(19) United States
(12) Patent Application Publication
(10) Pub. No.: US 2005/0178734 A1
(43) Pub. Date: Aug. 18, 2005

(54) Filter for use in closed vessels allowing the use of filter media which can be renewed without opening the vessel, and method of using same

(76) Inventors: Michael C. Kilmer, LaPorte, TX (US); Doyle J. Gould, Wallisville, TX (US)

Correspondence Address: THE MATTHEWS FIRM, 2000 BERING DRIVE, SUITE 700, HOUSTON, TX, 77057, US

(21) Appl. No.: 10/777,311

(22) Filed: Feb. 12, 2004

(51) Int. Cl. B01D 29/09; B01D 29/62

(52) U.S. Cl. 210/791; 210/387

(57) ABSTRACT

A filter for use in filtering solids from liquids and/or gases is provided with an elongated tube having a filter media wrapped along its length, around its perimeter, and the filter media is renewed, either on a continuous basis or on a timed basis by activating a pump to rotate a filter media take-up roll contained within the interior of the porous tube, which then causes the filter media to move around the exterior of the porous tube. The porous tube may be ceramic, hard plastic or a perforated metallic material, or may be a screen which underlies the filter media.

It is well known to use filters within the interior of reactors or other closed vessels such as closed pressure vessels. By way of example, U.S. Pat. No. 6,428,593; U.S. Pat. No. 6,413,422; U.S. Pat. No. 5,948,257 and U.S. Pat. No. 5,849,375 are patents directed to candle filters known in the art. The invention is not limited to candle filters, but can be used with other filters, including but not being limited to cartridge filters, dust filters and the like. It is well known that the candle filters are typically made from a porous ceramic material which are designed so that, in the event of failure, the filters do not fail catastrophically.

Filters in this art are oftentimes self-supporting and are shaped like long tubes, with one open end and one closed end. Such filters are typically fastened within an enclosure, which is divided into clean and dirty sides such that the fluid to be filtered traverses from the dirty side to the clean side of the enclosure by passing through the filter. The fluid typically flows from the outside to the inside of the filter, thus providing a fluid exiting from the open end thereof having an acceptable level of particles.

It is also known in the prior art that such filters can and do use various filter media to filter out the various particles residing in the fluid stream. It is also well known that such filter media tend to clog up and have to be replaced periodically. With the devices known in the prior art for use with closed vessels, for example, with reactors, the reactor has to first be shut down and then opened up and the filter media replaced. This is a timely, expensive operation to shut the reactor down and clean it up and various prior art patents have attempted to remedy the problem. For example, there have been attempts to back flush the filter media but these attempts have been usually somewhat unsuccessful. Such a back flush system is described in U.S. Pat. No. 5,948,257, with the back flush system sometimes referred to as “reverse pressurization”. There is also described in U.S. Pat. No. 5,948,257 the known process of using metal tubes instead of ceramic tubes to make such tubes less susceptible to the pressures encountered with the back flush process. Although metal tubes can be used with the present invention, there is described in U.S. Pat. No. 5,948,257 problems which have been encountered when using metal tubes instead of ceramic tubes.

It is also known to use filters which are renewed in open vessel configurations such as air filters used with air conditioning units and with furnace units, such as, for example, as shown in U.S. Pat. No. 2,853,155; U.S. Pat. No. 2,881,861; U.S. Pat. No. 3,985,528; U.S. Pat. No. 3,276,191; U.S. Pat. No. 4,054,521; U.S. Pat. No. 4,470,833; U.S. Pat. No. 4,221,576 and U.S. Pat. No. 6,152,998.

### BRIEF DESCRIPTION OF THE DRAWINGS

FIG. 1 is an elevated view, partly in cross section, of a filter according to the present invention;

FIG. 2 is a top plan, diagrammatic view taken along the sectional line 2-2, illustrated in FIG. 1;

FIG. 3 is a second view of the cross-sectional view illustrated in FIG. 2 but having the filter media in place in accordance with the invention over the plurality of rollers illustrated in FIGS. 1, 2 and 3;

FIG. 4 illustrates a cross-sectional view of an alternative embodiment of the present invention in which the tube for the filter is circular in cross-section;

FIG. 5 illustrates an elevated view, partly in cross section, of an alternative embodiment of the rollers used with the filters according to the present invention;

FIG. 6 illustrates, in block diagram, a system for rotating the take-up roll for the moving filter media according to the present invention;

FIG. 7 illustrates, schematically, the use of a plurality of filters within a closed vessel as contemplated by the invention;

FIG. 8 is an elevated view, partly in cross-section, of an alternative embodiment of the present invention;

FIG. 9 is a top plan view taken along the section line 9-9 illustrated in FIG. 8;

FIG. 10 is an elevated view of a segment of filter media according to the present invention;

FIG. 11 is an elevated view, in cross-section, taken along the section line 11-11 illustrated in FIG. 10;

FIG. 12 is a diagrammatic view of a static seal used with the filter according to the present invention;

FIG. 13 is a diagrammatic view of a spring-loaded seal used in accordance with the present invention;

FIG. 14 is a diagrammatic view of a triangular seal used in accordance with the present invention; and

FIG. 15 is a diagrammatic view of an alternative embodiment of a seal which can be used with the present invention.

### DETAILED DESCRIPTION OF THE PREFERRED EMBODIMENT

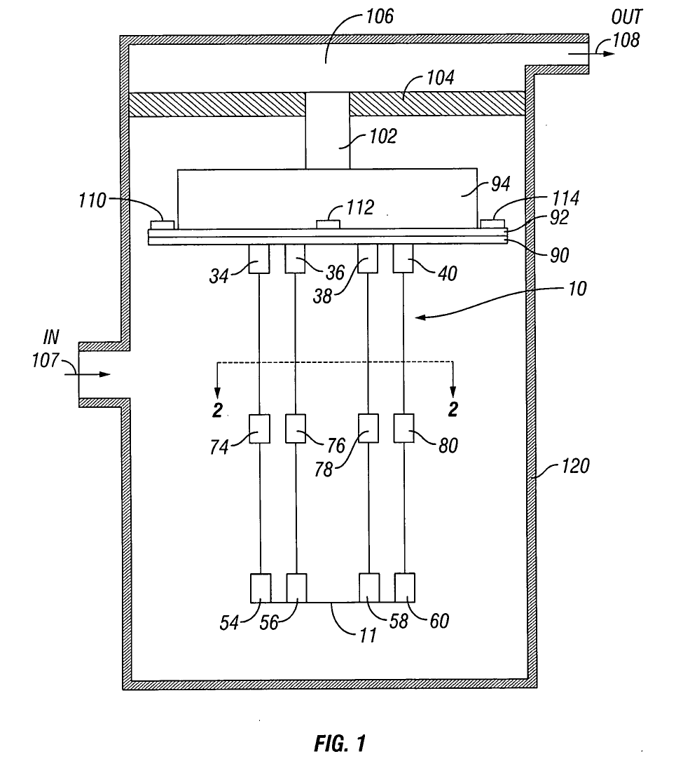

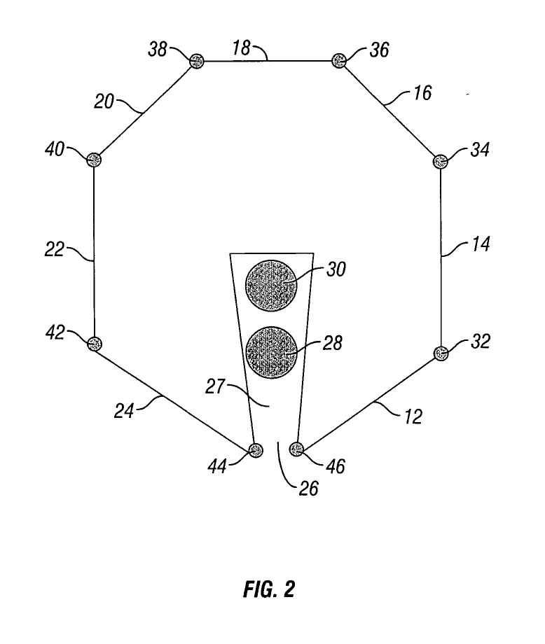

Referring now to the drawings in more detail, especially to FIGS. 1, 2 and 3, there is illustrated an elevated view of a filter according to the present invention, with FIG. 2 being a cross-sectional, diagrammatic view taken along the sectional lines 2-2 illustrated in FIG. 1. It should be appreciated that in FIG. 1, the filter 10 is essentially an octagonally shaped device but which has only seven sides 12, 14, 16, 18, 20, 22 and 24, with the sides 12 and 24 being slightly longer than the other five sides and having a cutout section 26 between the sides 12 and 24 which holds a source of filter media 28 and a take-up roll 30 for holding the spent filter media, as contemplated by this invention. It should be appreciated that the cut-out section 26 in the preferred embodiment runs along the entire length of filter 10, between its top end and bottom end, to allow the filter media to pass in and out of the filter 10, all the way from the filter media containment area 27 to the external surface or surfaces of the filter 10. The filter media containment area 27 is merely a space located within the interior of the porous tube which is large enough to contain the filter source roll and the filter media take-up roll. Although not illustrated, the filter media containment area 27 will typically have a pair of spindles having spines made up with the interior opening of the rolls, which can be fabricated as ratcheting devices, if desired, to prevent rotation except in one direction, if desired. It does not matter whether the roll 28 is the source or the take-up toll and likewise for the roll 30. One of the rolls is the source and the other is the take-up. As illustrated in FIG. 2, a plurality of rollers are located, respectively, at the respective apexes at which the respective sides of the filter come together. For example, the roller 32 is located at the meeting point of the sides 12 and 14. In a similar way, the roller 34 is at the junction of the sides 14 and 16, and the roller 36 is at the junction of sides 16 and 18. Roller 38 is located between sides 18 and 20 and a roller 40 is located at the junction of the sides 20 and 22. A roller 42 is located at the junction of the sides 22 and 24. A pair of rollers 44 and 46 are located on opposite sides of the opening 26 leading to the containment area 27 within which the filter media source 28 and the take-up roll 30 are located.

In using the device illustrated in FIG. 2, the filter media 28 is hand rolled from the source 28 to extend past the rollers 46, 32, 34, 36, 38, 40, 42 and 44 and then wound onto the take-up roll 30.

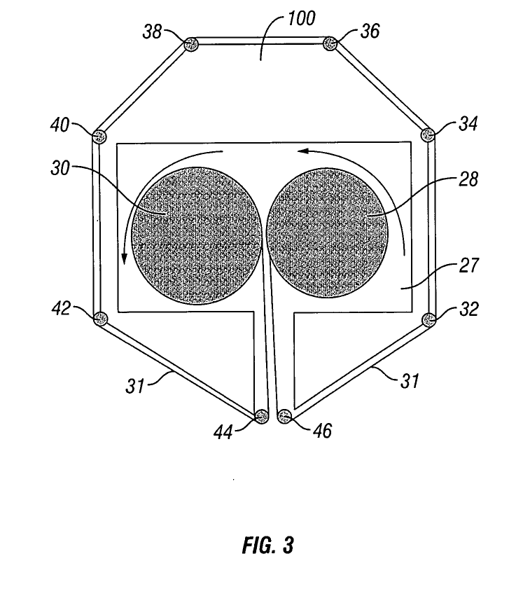

Referring now to FIG. 3, there is a diagrammatic view of a filter media 31 having been hand rolled over the rollers as above discussed with respect to FIG. 2. Because FIG. 2 and FIG. 3 are merely diagrammatic views, the filter media source 28 and take-up rolls 30 are oriented slightly different, but the function of the filter media source roll and the take-up roll is identical in FIGS. 2 and 3.

Referring again back to FIG. 1, the elevated view of the filter 10, according to the present invention, illustrates the rollers 34, 36, 38 and 40 as being at the upper end of the filter 10. A second set of such rollers are illustrated at the lower end of the filter 10 and numbered as rollers 54, 56, 58 and 60. It should be appreciated that rollers 54, 56, 58 and 60 are the only ones which would be visible from the view as illustrated in FIG. 1, but there are four corresponding rollers 42, 44, 46 and 32 located on the blind side of filter 10, as illustrated in FIGS. 2 and 3, and also four other rollers (not illustrated) on the blind side of the upper end of the filter 10.

A third set of rollers, which are optional, are located in the center portion of the filter 10 and are identified as being rollers 74, 76, 78 and 80 which would also have counterparts in the middle section of the filter 10, but which are one the blind side of the filter and are thus not illustrated.

A plate 90 is located at the top end of the filter 10 and is used to be bolted onto a second plate 92 which is connected to the housing 94. A center hole (not illustrated) passes through the housing 94 to allow the clean fluid product to pass from the interior 100 of the filter 10 (see FIG. 3) and pass through the housing 94 and the outlet pipe 102, which passes through a baffle plate 104 into the collection area 106, which then passes through the outlet port 108. The plates 92 and 90 are bolted together by a plurality of bolts 110, 112 and 114 and by other bolts (not illustrated) on the blind side of the housing 94.

In the operation of the filter 10, a “dirty” gas or other fluid containing solid particles is passed into an inlet port 107 into a closed vessel 120 containing the filter 10. It should be appreciated that the body of filter 10 typically is a porous ceramic material closed at its lower end 11 and opens at its upper end leading through the housing at the outlet pipe 102 to allow the “clean” fluid to be gathered into the collection area 106. As with almost any filter system, as the dirty fluid passes through the filter media and through the porous ceramic body, the filter media will eventually clog up and lose its efficiency. With the conventional filter, this would have required the shutdown of the process and the removal of filter 10 to wrap the body of the filter 10 with new filter media, all of which is not only very time consuming but can be dangerous to the personnel involved with cleaning out the vessel 120.

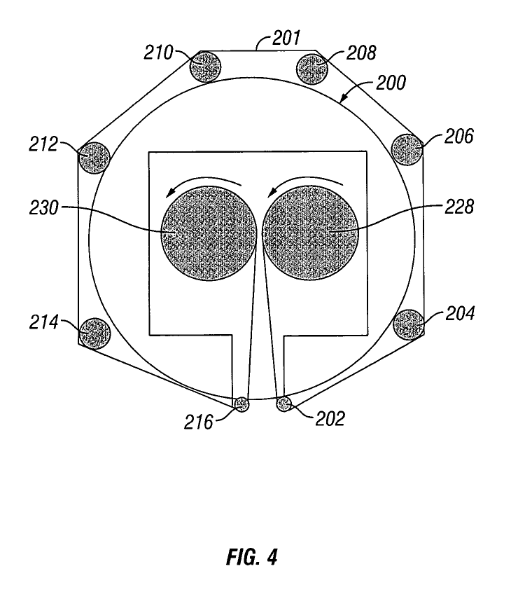

FIG. 4 illustrates an alternative embodiment of the present invention in which the tube 200 for the filter is circular in cross-section. FIG. 4 also shows a plurality of rollers 202, 204, 206, 208, 210, 212, 214 and 216. Within the interior of the tube 200, there is illustrated the take-up roll 230 and the filter media roll 228. The manual turning of the roll 230 causes the filter media to be stretched over the rollers 202-216, but once the process starts, the fluid flowing through the sidewall of the porous ceramic tube 200 will cause the filter media 201 to be pushed into contact with the exterior surface walls of the tube 200. The overall effect of the device shown in FIG. 4 mimics the effect of the device illustrated in FIG. 3 except for the filter media not making as intimate of contact with the round walls as does the filter media illustrated in FIG. 3 with respect to the flat walls.

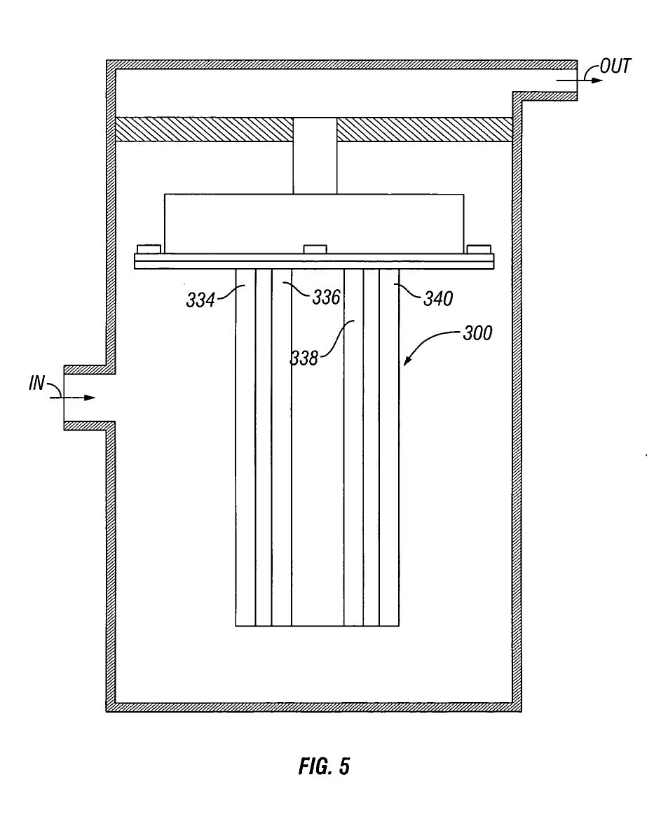

FIG. 5 illustrates an alternative embodiment of the present invention which uses rollers 334, 336, 338 and 340 and additional rollers which are located on the blind side of the filter 300. The embodiment of FIG. 5 operates essentially the same as the embodiment of FIG. 1, but instead of having two or three sets of rollers, the embodiment utilizes eight containment rollers which pass from the top of the filter 300 to the lower extreme of the filter 300, although there may be more or less than eight rollers depending upon the filter geometry. In all other respects, the embodiment of FIG. 5 is the same as the embodiment of FIG. 1.

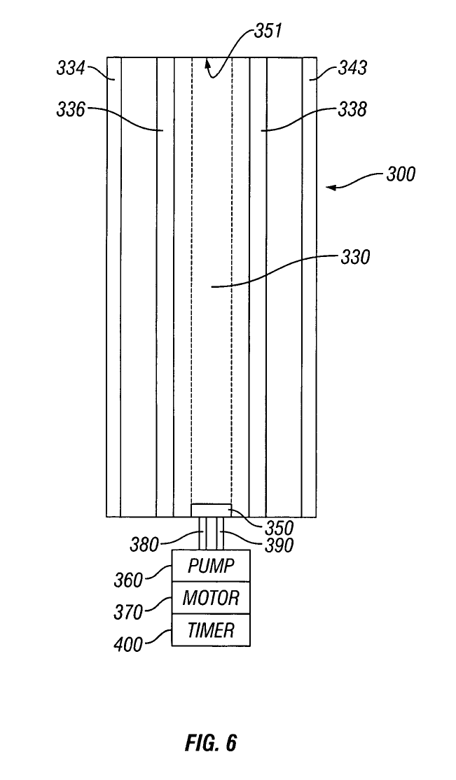

Referring now to FIG. 6, the filter illustrated in FIG. 5 is illustrated as having in dotted line an illustration of the take-up roll 330, which is functionally equivalent to take-up roll 30 in FIG. 3. In order to rotate the take-up roll 330, its lower end is mounted on a drive member 350 which can take several known forms such as having gear teeth or the like that when driven, cause the take-up roll 330 to rotate. A hydraulic pump 360 is driven by a motor 370, which may be pneumatic, electric or hydraulic. The pump 360 has a hydraulic line 390 which causes the drive member 350 to rotate, and return line 380 which returns the hydraulic fluid to the pump 360.

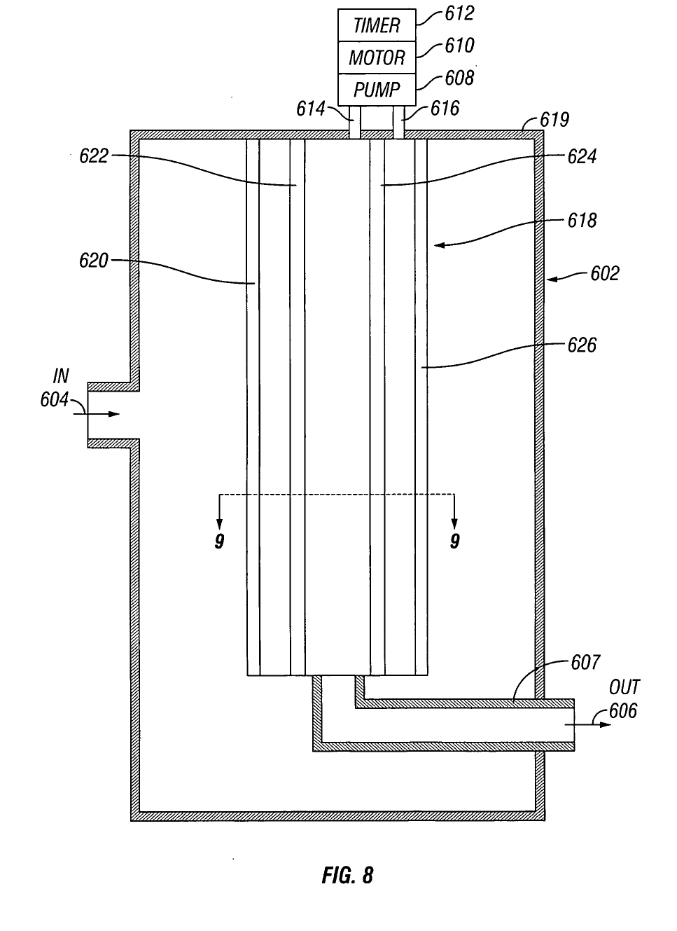

Alternatively, the drive mechanism 350, and the associated components 350, 380, 390, 360, 370 and 400 can be located at the upper end 351 of the filter 300 to cause the take-up roll 330 to rotate, for example, as illustrated in FIG. 8.

The filter media, which is advanced in these various embodiments of the invention, can be so advanced in a variety of ways. The pump 360 and the motor 370 can be activated by a timer 400, which can be set to rotate the filter media around the exterior of the filter once every so many days, for example, once every ten days, every twenty days, or whatever number of days, or even hours, which may be required to insure that the filter media surrounding the filter stays relatively clean. Alternatively, the motor and pump can be set to cause the drive member 350 to rotate continuously, but more slowly, to keep the filter media constantly renewing itself. Alternatively, the take-up roll can be rotated by a hand crank (not illustrated) to advance the filter media. By monitoring the differential pressure across the filter media, the operator knows when to rotate the hand crank.

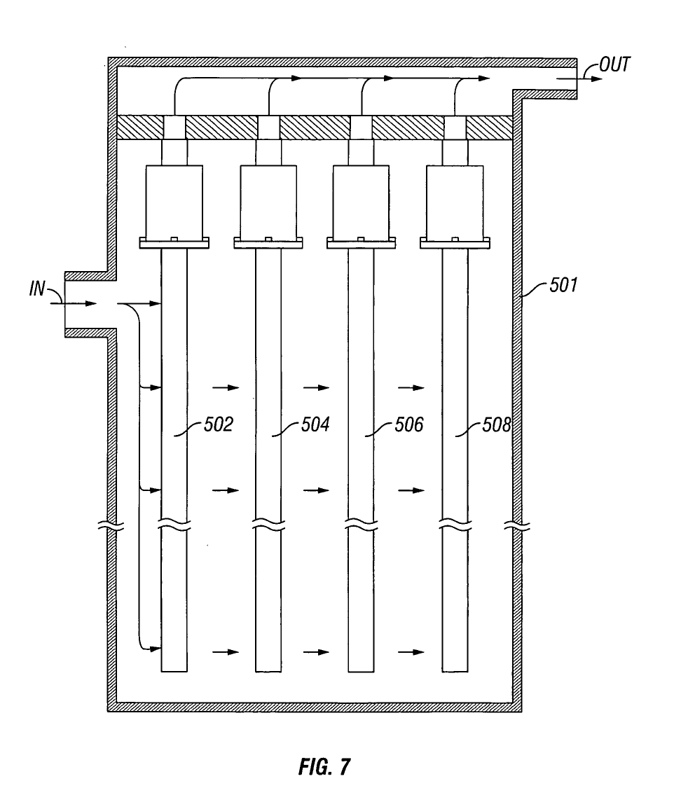

Referring now to FIG. 7, there is illustrated the use of a plurality of filters within the confines of a closed vessel 501, such as the vessel 120 illustrated in FIG. 1. Although FIG. 7 illustrates only the use of four such filters identified as filters 502, 504, 506 and 508, it is fairly commonplace to use twenty-six such filters in a single reactor which is used for producing tetrahydrofuran, commonly referred to as “THF”.

For each illustration, filters 502, 504, 506 and 508 are illustrated in FIG. 7 without having the rollers of FIGS. 1, 2, 3, 4, 5 or 6, but one or more of such rollers and their equivalents are intended to be used with each such filter when practicing the invention.

THF is manufactured from furan, a heterocyclic compound. THF is derived either from the catalytic hydrogenation of furan with nickel catalysts or from the acid-catalyzed dehydration of 1,4-Butanediol. THF is moderately toxic by ingestion and inhalation, but is somewhat more dangerous as a flammable fire risk since exposure of THF to air can cause combustion.

One of the processes which can be used with the apparatus and methods of the present invention involves the reaction of the catalytic hydrogenation of furan with a nickel catalyst, but because of the fire risk, it is better to leave the vessel closed as long as possible. One of the ways of achieving that result is to allow the filters to be renewing their filter media without opening up the closed vessel, which is achieved by causing the filter media to be renewed around the exterior of the filter, as presently disclosed.

It should be appreciated that the rollers which are utilized as described herein, whether being the sets of rollers as described in FIG. 1 or the elongated rollers which are described in respect to FIGS. 5, and 6, all function to reduce the friction between the filter media which is being moved around the exterior of the filter, and the exterior wall or walls of the filter itself. Whether the filter tube is itself circular or has a discreet number of flat walls, such as are illustrated in FIGS. 2 and 3, the flat wall variety of the filter can have any number of such walls other than having the seven or eight walls contemplated by FIGS. 2 and 3. The filter tube can be a triangle in cross section, a square, a rectangle, or have five, six or even nine or more walls, if desired. It is important, however, that each of the points at which there is located a meeting of two flat walls, that there be a roller assembly to reduce friction.

It should be appreciated that although the preferred embodiment contemplates the use of ceramic as material for the porous tube used with the filter of the present invention, such tubes can also be made from hard plastic, for example, high density urethane or polyurethane, or from various metals such as steel, aluminum, stainless steel and the like, and may be made porous by perforations or slots fabricated therein as in well-known in the art of filters. Such tubes can also be made of various screen materials, for example from metallic screens which can be used underneath the filter media.

Although the preferred embodiment contemplates the gas or liquid being filtered to pass from the outside of the filter to the inside of the filter, the process works quite well having a liquid or gas pass from the inside of the filter to the outside of the filter, a process that still allows the filter media to be renewed, as described herein.

Almost any woven, cast, or thermally formed filter media can be employed in the filter according to the present invention. Examples include:

| | |
|---|---|
| 1) | Polypropylene |
| 2) | Polyester |
| 3) | Cotton |
| 4) | Rayon |
| 5) | Nomex |
| 6) | Teflon |
| 7) | Stainless Mesh |
| 8) | Fiberglass |
| 9) | Nylon |
| 10) | Kevlar |
| 11) | Combination of items 1-10, above. |

Referring now to FIG. 8, there is illustrated an alternative embodiment of the present invention which shows a filter 618 according to the present invention, but which is attached to the ceiling 619 of a closed vessel 602 which can be used for various functions, including that of being a chemical reactor. The vessel 602 can also contain dirty liquids which have been injected into the “in” portal 604 of the vessel 602. It should be noted that in this embodiment, the vessel has an “out” portal 606 which makes use of gravity to evacuate the fluid, for example, a clean liquid which is passed through the filter 618 suspended in the pressure vessel 602.

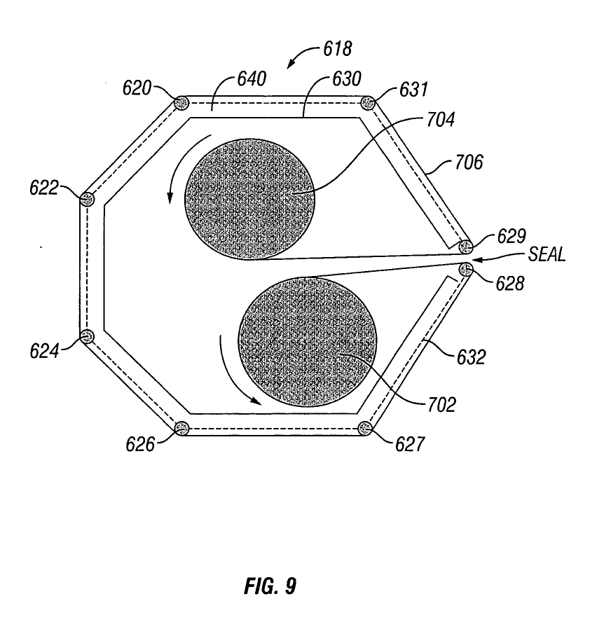

In the embodiment of FIG. 8, the pump 608, a motor 610 and a timer 612 are used at the top portion of the filter 618, which uses a pair of hydraulic lines 614 and 616 to rotate the take-up roll 702 illustrated in FIG. 9 hereinafter.

Referring now to FIG. 9, which is a cross-sectional view taken along section lines 9-9, illustrated in FIG. 8, there is illustrated a take-up roll 702 and a filter media source roll 704 which together enable the filter media 706 to be renewed as needed, and as further described herein with respect to the other embodiments of the invention. The filter 618, illustrated in FIGS. 8 and 9, uses rollers 620, 622, 624, 626, 627, 628, 629 and 631 to reduce friction as the filter media is being renewed, all as set forth herein before.

FIG. 9 also illustrates an annular member 630 which is non-porous and which runs the length of the filter 618 illustrated in FIG. 8. The annular area between the member 630 and the porous member 632 is referred to hereinafter as an annular clean fluid collection area 640. To some extent, the annular clean fluid collection area 640 also includes any space between the porous member 632 and the filter media 706. The purpose of the annular clean fluid collection area 640 is a further attempt to prevent clear fluid from being contaminated by the dirty fluid which is external to the filter media 706.

The annular clean fluid collection area 640 is connected to conduit 607 which thus allows the clean fluid to pass from the annular clean fluid collection area 640 from the “out” protal 606 into whatever storage area or conduit is desired (not illustrated).

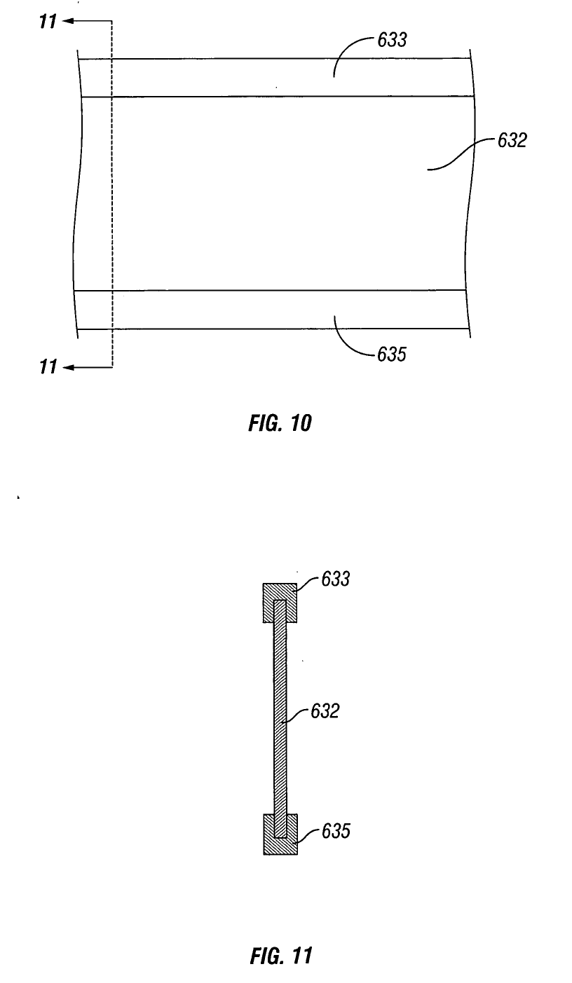

Referring now to FIG. 10, there is illustrated a partial, elevated view of the filter media 632 which can encircle the filter illustrated as filter 618 in FIG. 9. Attached to the top portion of filter media 632 is a strip 633 of the sealing material. A similar strip of such sealing material 635 is attached along the length of filter media 632, and which is attached to filter media 632 on the lower extreme of the filter media 632. As illustrated in FIG. 11, there is a cross-sectional view taken along section lines 11-11 illustrated in FIG. 10 which shows the manner in which strips 633 and 635 attach to filter media 632. If desired, the strips 633 and 635 mat be thermally fused to the filter media 632. The strips 633 and 635 may be fabricated of various materials, including Viton and Teflon. The filter media 632 may be of various materials as set forth herein above.

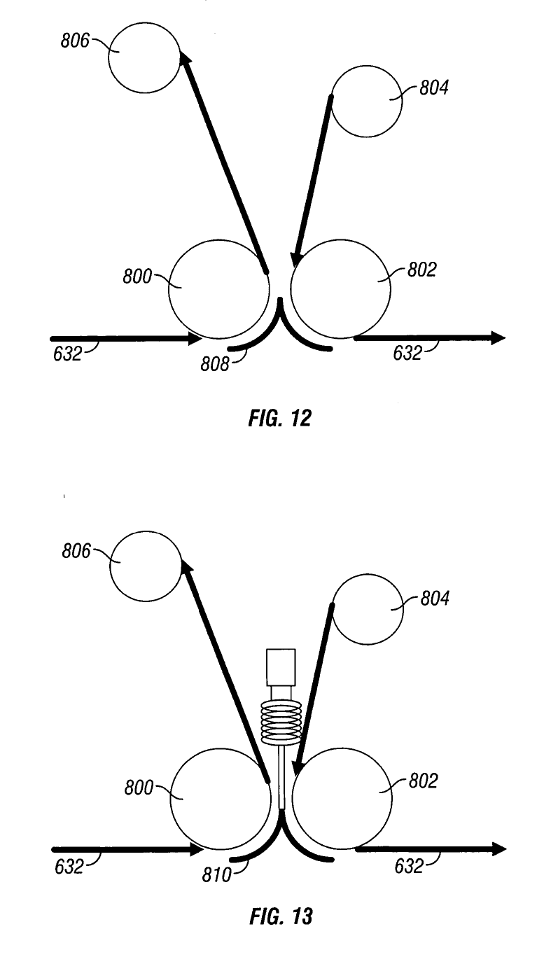

Referring now to FIG. 12, there is schematically illustrated the rollers 800 and 802 which are located at the entrance to the filter through which the filter media passes from the supply roll 804 and which after encircling the filter comes back to the take-up roll 806. The embodiment of FIG. 12 is an alternative embodiment of the embodiment illustrated in FIGS. 10 and 11, but which can be used in combination with the embodiment of FIGS. 10 and 11. FIG. 12 includes a static seal which runs along the length of the filter, such as the filter 618 of FIG. 9. The seal material 808 may be any material of choice such that a seal is provided between the filter media 632 and the roller 800 and between the roller 802 and the filter media 632. Because of the configuration of static seal 808, which runs the length of filter 618, the dirty fluid cannot enter into the center portion of the filter housing containing the take-up roll 806 and the supply roll 804.

Referring now to FIG. 13, there is illustrated another apparatus for sealing the entrance through the rollers 800 and 802, but instead of having a static seal 808, there is illustrated a spring loaded seal 810 which generates a tighter seal between filter media 632 and the seal 810.

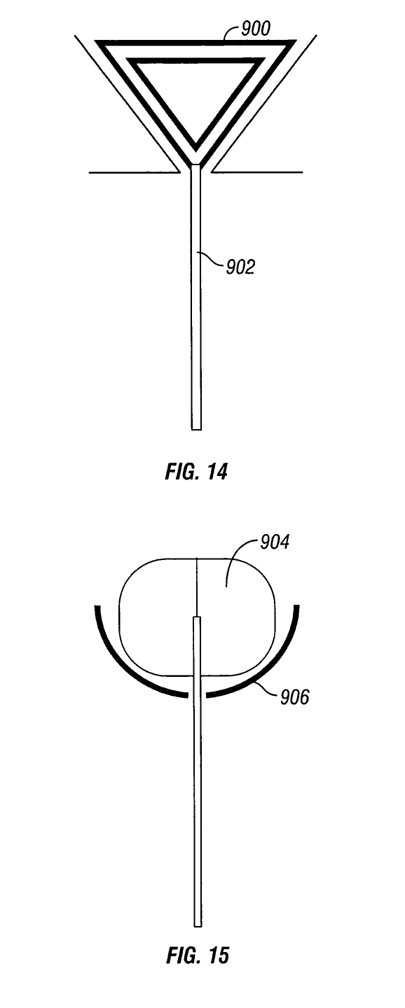

FIG. 14 illustrates yet another seal 900 which is fabricated in the shape of a triangle. It should be appreciated that the triangle seal 900 runs the entire length of the filter such as the filter 618. The leading apex of the triangle 900 has attached thereto an arm 902 which can be used to tighten the triangular configuration within the entrance of the filter body and may be locked in place after tightening as desired.

FIG. 15 is an alternative embodiment of a sealing member 904 which can be pulled down tight to seal against a static seal 906 to accomplish similar results as does the triangular seal 900 of FIG. 14.

Thus, there has been described and disclosed herein various sealing configurations for sealing the entrance from the exterior of the filter 618 into the interior of the filter 618 containing the filter media rolls 704 and 702 of FIG. 9.

1. A filter for use in a closed vessel, comprising;
a porous tube located within said closed vessel, said tube having a tubular wall, a first closed end and a second open end, and a filter media containment area within the interior of said porous tube between said first and second ends;
a first roll of unused filter media and a second take-up roll for taking up the filter media as it is spent in the process of operating said filter, said first and second rolls being located within the containment area of said porous tube, a length of said filter media being wrapped around the external surface or surfaces of said porous tube and being connected between said first roll and second roll such that when said take-up roll is rotated, the spent filter media is rolled up on the take-up roll.

2. The filter according to claim 1 including, in addition thereto, a plurality of rollers mounted on or near the external surface or surfaces of said porous tube to reduce the friction between the external surface or surfaces of said porous tube and the filter media itself.

3. The filter according to claim 2 including, in addition thereto, means for rotating said take-up roll as needed to thereby renew the filter media which wraps around the exterior surface or surfaces of said porous tube.

4. The filter according to claim 3 including, in addition thereto, a passageway extending between said filter media containment area and the exterior of said porous tube to allow the media filter to pass between said first and second rolls and the exterior surface or surfaces of said porous tube.

5. The filter according to claim 1 wherein said porous tube is circular in cross-section and has only a single external surface.

6. The filter according to claim 1 wherein said porous tube is non-circular in cross-section and has a plurality of flat sides, each of said sides extending between the first and second ends of said porous tube.

7. The filter according to claim 2, wherein at least one of said plurality of rollers extends between the first and second ends of said porous tube.

8. The filter according to claim 2 wherein each of said plurality of rollers extends between the first and second ends of said porous tube.

9. The filter according to claim 2 wherein said plurality of rollers are arranged in first and second spaced-apart sets, with a first set of said rollers being at or near the first end of said porous tube and the second set being at or near the second end of said porous tube.

10. The filter according to claim 2 including, in addition thereto, a third set of rollers spaced intermediate said first and second sets of rollers.

11. The filter according to claim 1, wherein said porous tube is comprised of ceramic.

12. A filter for use in a closed vessel, comprising:
a porous tube located within said closed vessel, said tube having a tubular wall, a first closed end and a second open end, and a filter media containment area within the interior of said porous tube between said first and second ends;
a first roll of unused filter media and a second take-up roll for taking up the filter media as it is spent in the process of operating said filter, said first and second rolls being located within the containment area of said porous tube, a length of said filter media being wrapped around the external surface or surfaces of said porous tube and being connected between said first roll and second roll such that when said take-up roll is rotated, the spent filter media is rolled up on the take-up roll; and
means for rotating said take-up roll within said porous tube within said vessel while said vessel is closed.

13. The filter according to claim 12 including, in addition thereto, a plurality of rollers mounted on or near the external surface or surfaces of said porous tube to reduce the friction between the external surface or surfaces of said porous tube and the filter media itself.

14. The filter according to claim 13 wherein said porous tube is circular in cross-section and has only a single external surface.

15. The filter according to claim 13 wherein said porous tube is non-circular in cross-section and has a plurality of flat sides, each of said sides extending between the first and second ends of said porous tube.

16. A method for renewing filter media used with a filter for removing solids from a fluid within a closed vessel;
placing a source roll of filter media and a filter media take-up roll within the interior of an elongated filter tube;
rolling the filter media from the source roll around the perimeter of the filter tube until the filter media can be threaded back into the filter media take-up roll; and
rotating said filter media take-up roll to renew the filter media around the perimeter of said filter tube without opening up the closed vessel within which the filter tube is located.

17. The method according to claim 16 wherein said filter is a candle filter.

18. The method according to claim 16 wherein said filter is a dust filter.

19. The method according to claims 16 wherein said filter is a cartridge filter.

20. The method according to claim 16 wherein said filter tube is circular in cross-section and has only a single external surface.

21. The method according to claim 16 wherein said filter tube is non-circular in cross-section and has a plurality of flat sides, each of said sides extending between the first and second ends of said porous tube.

22. The method according to claim 16 wherein at least one of said plurality of rollers extends between the first and second ends of said porous tube.

23. The method according to claim 16 wherein each of said plurality of rollers extends between the first and second ends of said porous tube.

24. The method according to claim 16 wherein said plurality of rollers are engaged in first and second spaced-apart sets, with a first set of said rollers being at or near the first end of said porous tube and the second set being at or near the second end of said porous tube.

25. The method according to claim 16 including, in addition thereto, a third set of rollers spaced intermediate said first and second sets of rollers.
